(19) United States
(12) Patent Application Publication
(10) Pub. No.: US 2003/0202606 A1
(43) Pub. Date: Oct. 30, 2003

(54) Multi-phase processing for real-time display of a compressed video bitstream

(76) Inventor: Michael Tinker, Yardley, PA (US)

Correspondence Address: Steve Mendelsohn, Mendelsohn & Associates, P.C., Suite 715, 1515 Market Street, Philadelphia, PA, 19102, US

(21) Appl. No.: 10/351,774

(22) Filed: Jan. 27, 2003

Related U.S. Application Data
(60) Provisional application No. 60/370,429, filed on Apr. 5, 2002.

(51) Int. Cl. H04N 7/12

(52) U.S. Cl. 375/240.27; 382/244

(57) ABSTRACT

A pre-processor partially or fully decompresses a compressed video bitstream and possibly lightly compresses the resulting partially/fully decompressed video data to generate video data in a second format different from that of the original bitstream. The video data in the second format is then stored for subsequent retrieval and possible further processing for display. By pre-processing the compressed video bitstream, the subsequent retrieval and further processing is able to achieve real-time display of the video content of the original bitstream using relatively inexpensive equipment. Depending on the implementation, the subsequent further processing may involve undoing the light compression and/or completing the decompression of the original bitstream to generate display-ready video data.

### CROSS-REFERENCE TO RELATED APPLICATIONS

This application claims the benefit of the filing date of U.S. provisional application No. 60/370,429, filed on Apr. 5, 2002 as attorney docket no. SAR 14734P.

### BACKGROUND OF THE INVENTION

1. Field of the Invention

The present invention relates to video processing, and, in particular, to the decoding of compressed video data.

2. Description of the Related Art

Digital cinema replaces film with digital imagery. This reduces the cost of distributing movies to multiple theatres. Typically, the movie is compressed to reduce the size to a point where it can easily be moved to a theatre using means available today, e.g., using transmission methods such as fiber or satellite or physical media such as DVDs or removable hard drives. However, equipment (e.g., custom hardware) to decompress the compressed video bitstream for such a movie in real-time is expensive.

### SUMMARY OF THE INVENTION

The problems in the prior art are addressed in accordance with the principles of the present invention by a multi-phase video processing architecture in which the received compressed video bitstream is pre-processed during a first processing phase in which the results are stored for subsequent retrieval and possible further processing during a second processing phase associated with display of the video content. The pre-processing associated with the first processing phase is preferably designed such that the corresponding further processing of the second processing phase can be implemented using relatively inexpensive equipment while still enabling the video content to be displayed in real-time. Real-time display refers to the ability to render the video content of the original video bitstream in a continuous manner in which the timing of the video playback is the same as the timing of the original production that was encoded into the original bitstream. In general, the term “real-time” means the appropriate number of frames-per-second for the video content.

The multi-phase video processing architecture of the present invention can be implemented in a variety of different ways. In general, the first processing phase involves either partially or fully decoding the original received video bitstream (e.g., more slowly than real-time using relatively inexpensive equipment), optionally combined by lightly compressing (preferably losslessly) the results of the partial/full decoding, to generate video data in a format different from that of the original bitstream, where that video data is stored for subsequent retrieval and possible further processing during the second processing phase. The type of processing implemented during the second processing phase depends on the type of processing implemented during the first processing phase. Depending on the particular processing details, this second processing phase may involve undoing the light compression and/or completing the decoding of the original video bitstream. If the first processing phase involves fully decoding the original video bitstream without adding any subsequent light compression, the second processing phase would involve simply retrieving the display-ready video data from storage.

In any case, the multi-phase processing architecture of the present invention is preferably designed such that the second processing phase can be implemented to achieve real-time display of the video content using relatively inexpensive equipment, thereby achieving an advantageous combination of efficient transmission of compressed video bitstreams and high-quality video playback using inexpensive equipment. Although the present invention involves the storage of the video data generated during the first processing phase to await retrieval during the second processing phase, disc storage is relatively inexpensive and rapidly declining in cost. It is expected that the cost of architectures in accordance with the present invention will continue to decline more rapidly than prior-art approaches that require relatively expensive custom hardware to achieve real-time decode and display of compressed video bitstreams of comparable quality in a single processing phase.

According to one embodiment, the present invention is a method comprising (a) receiving a compressed video bitstream conforming to a first video format; (b) processing the compressed video bitstream to generate video data in a second video format different from the first video format; (c) storing the video data in the second video format; and (d) retrieving and processing the stored video data for display.

According to another embodiment, the present invention is a video server, comprising (a) a memory; (b) a pre-processor connected to the memory; and (c) a display processor connected to the memory. The pre-processor is adapted to (i) receive a compressed video bitstream conforming to a first video format, (ii) process the compressed video bitstream to generate video data in a second video format different from the first video format, and (iii) store the video data in the second video format into the memory. The display processor is adapted to retrieve and process the stored video data for display.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a multi-phase video server, according to one embodiment of the present invention; and

FIGS. 2-5 shows flow diagrams of the processing of the video server of FIG. 1 according to four different implementations of the present invention.

### DETAILED DESCRIPTION

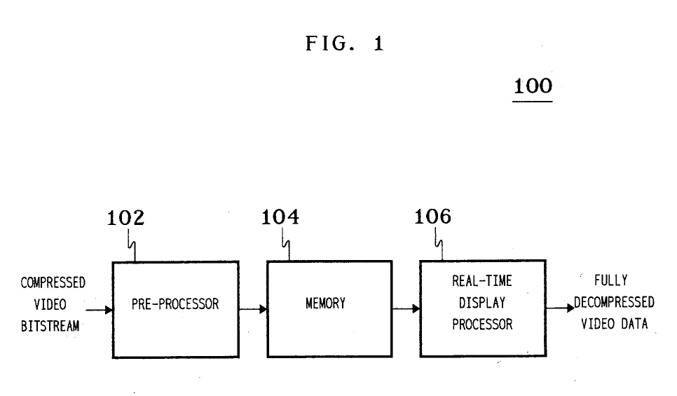

FIG. 1 shows a block diagram of a multi-phase video server 100, according to one embodiment of the present invention. As shown in FIG. 1, server 100 comprises pre-processor 102, memory 104, and real-time display processor 106. In a preferred implementation, server 100 is implemented using a personal computer (PC), in which case, both pre-processor 102 and display processor 106 may be implemented in software running on the PC's general-purpose processor, and memory 104 may be the PC's hard drive. For example, server 100 may be implemented in a PC having a 600-GByte (or larger) hard drive and a dual 1.5-GHz Pentium® processor from Intel Corporation of Santa Clara, Calif. In alternative implementations, either pre-processor 102 or display processor 106 or both may be implemented using one or more (e.g., custom hardware) video processors configured in the PC.

Pre-processor 102 receives a compressed video bitstream in a first video format (e.g., conforming to a first video compression standard) and processes the compressed video data to generate video data in a second video format (e.g., conforming to the same or a different video compression standard) that is then stored to memory 104. Depending on the particular implementation, the compressed video bitstream may be received from a remote transmitter (e.g., via fiber or satellite) or from a local storage device (e.g., a DVD or hard drive). In typical applications, the receipt and processing of the compressed video bitstream by pre-processor 102 is performed and completed off-line, that is, prior to the subsequent display of the video content by display processor 106. Depending on the implementation, the compressed video bitstream may be processed by pre-processor 102 as it is received or the compressed video bitstream may be stored (e.g., to memory 104) prior to being processed by pre-processor 102. Similarly, pre-processor 102 may temporarily store intermediate data to memory 104 during its processing.

As just suggested, at some later time, display processor 106 retrieves the stored video data in the second video format from memory 104 and further processes that data as needed to generate fully decompressed video data ready for display. In preferred implementations, the retrieval and processing of the stored video data is performed in real-time such that the decompressed video data is sent for display as it is generated (not counting the buffering of one or more frames of video data needed to achieve the proper sequence of frames for display and/or account for minor variations in the bit rate and processing time from frame to frame resulting from the particular video compression algorithm used to generate the stored video data in the second video format).

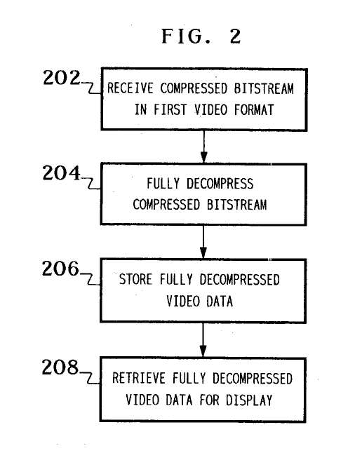

As described previously, the multi-phase processing of server 100 can be implemented in a variety of manners. Some of these are described in the following paragraphs in connection with FIGS. 2-5.

FIG. 2 shows a flow diagram of the processing implemented by server 100 of FIG. 1, according to one implementation of the present invention in which pre-processor 102 fully decompresses the original video bitstream for storage in memory 104. In particular, pre-processor 102 receives the compressed video bitstream in the first video format (step 202 of FIG. 2), fully decompresses the video bitstream (step 204), and stores the fully decompressed (i.e., display-ready) video data to memory 104 (step 206). Subsequently (e.g., when the video content is to be displayed in a movie theatre), display processor 106 retrieves the fully decompressed video data from memory 104 and forwards it on for display without having to change the format of the stored video data (step 208).

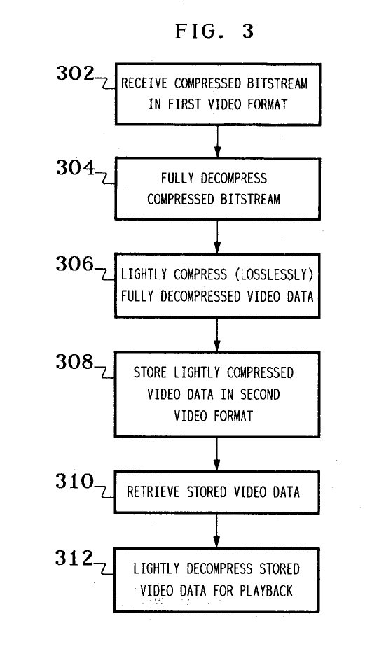

FIG. 3 shows a flow diagram of the processing implemented by server 100 of FIG. 1, according to another implementation of the present invention in which pre-processor 102 fully decompresses the original video bitstream and then lightly compresses the fully decompressed video data for storage in memory 104. In particular, pre-processor 102 receives the compressed video bitstream in the first video format (step 302 of FIG. 3), fully decompresses the video bitstream (step 304), lightly compresses the fully decompressed video data into a second video format different from the first video format of the original video bitstream (step 306), and stores the lightly compressed video data in the second video format to memory 104 (step 308). Subsequently, display processor 106 retrieves the lightly compressed video data from memory 104 (step 310) and decompresses the lightly compressed video data and forwards the resulting fully decompressed video data on for display (step 312). Preferred light compression algorithms will be discussed later in this specification in the section entitled “Exemplary Video Formats.”

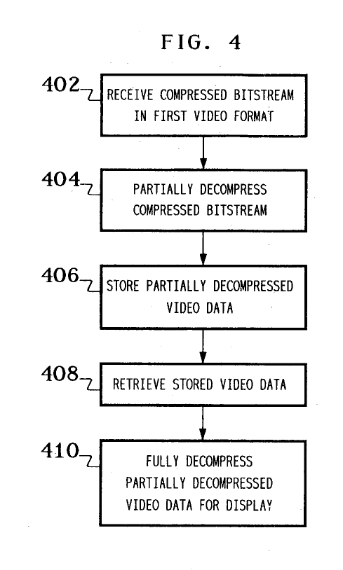

FIG. 4 shows a flow diagram of the processing implemented by server 100 of FIG. 1, according to yet another implementation of the present invention in which pre-processor 102 partially decompresses the original video bitstream for storage in memory 104. In particular, pre-processor 102 receives the compressed video bitstream in the first video format (step 402 of FIG. 4), partially decompresses the video bitstream (step 404), and stores the partially decompressed video data to memory 104 (step 406). Subsequently, display processor 106 retrieves the partially decompressed video data from memory 104 (step 408) and completes the decompression of the partially decompressed video data and forwards the resulting fully decompressed video data on for display (step 410). Preferred partial decompression processing will be discussed later in this specification in the section entitled “Exemplary Video Formats.”

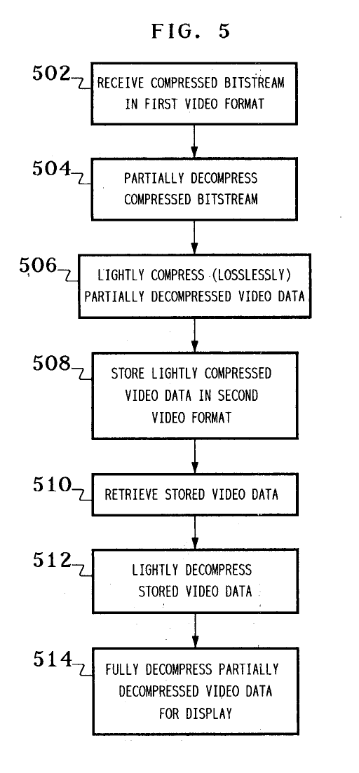

FIG. 5 shows a flow diagram of the processing implemented by server 100 of FIG. 1, according to still another implementation of the present invention in which pre-processor 102 partially decompresses the original video bitstream and then lightly compresses the partially decompressed video data for storage in memory 104. In particular, pre-processor 102 receives the compressed video bitstream in the first video format (step 502 of FIG. 5), partially decompresses the video bitstream (step 504), lightly compresses the resulting partially decompressed video data into a second video format different from the first video format of the original video bitstream (step 506), and stores the resulting lightly compressed video data in the second video format to memory 104 (step 508). Subsequently, display processor 106 retrieves the lightly compressed video data from memory 104 (step 510), decompresses the lightly compressed video data to recover the partially decompressed video data (step 512), and completes the decompression of the partially decompressed video data and forwards the resulting fully decompressed video data on for display (step 514).

Exemplary Video Formats

Conventional video compression algorithms, such as those belonging to the MPEG family of video compression standards, involve (optional) motion-compensated inter-frame differencing (for predicted frames), followed by block-based (e.g., DCT) transform of the resulting inter-frame pixel differences (for predicted frames) or the original pixel data (for intra frames and intra-coded blocks in predicted frames), followed by quantization of the resulting transform coefficients, followed by run-length coding (RLC) of the quantized coefficients, followed by variable-length (e.g., arithmetic or Huffman) coding (VLC) of the resulting RLC codes. In addition, when motion compensation is performed, the corresponding motion vectors are also encoded into the resulting compressed video bitstream.

In order to playback such a compressed video bitstream, the compression processing steps are undone. In other words, the compressed video bitstream is decoded to recover the motion vectors and the VLC codes, the VLC codes are then decoded to recover the RLC codes, the RLC codes are then decoded to recover the quantized coefficients, the quantized coefficients are then dequantized to recover dequantized transform coefficients, an inverse transform is then applied to the blocks of dequantized transform coefficients to recover either pixel data or pixel difference data (depending on how the corresponding block of video data was encoded), and motion compensation is then applied to the pixel difference data based on the recovered motion vectors to recover display-ready pixel data.

In such video compression algorithms, the application of the inverse transform is the step during decompression processing that is typically the most computationally intensive. As such, in order to fully decode and display such a video bitstream in real-time in a single processing phase, relatively expensive video decompression equipment is required. According to preferred implementations of the present invention, however, pre-processor 102 will decode such a compressed video bitstream at least through the application of the inverse transform. For example, in the context of the full-decompression processing of FIGS. 2 and 3, pre-processor 102 fully decompresses the original video bitstream. In the context of the partial-decompression processing of FIGS. 4 and 5, pre-processor 102 decompresses the original video bitstream through the application of the inverse transform, e.g., generating partially decompressed video data in a format in which intra-coded blocks are represented by fully decompressed pixel data, while inter-coded blocks are represented by inter-frame pixel differences. In that case, display processor 106 simply has to perform motion compensation for those inter-coded blocks using the recovered motion vectors, which processing can be implemented in real-time using relatively inexpensive equipment.

The light compression of the present invention can take a wide variety of forms. For example, in one implementation in which the original compressed bitstream is in an MPEG format, the light compression involves re-encoding fully decompressed video data such that all frames are encoded as MPEG intra frames. In yet another possible implementation, the light compression involves inter-frame pixel differencing, but with motion compensation deactivated. Such light compression might involve only a subset of the compression steps applied when generating the original video bitstream (e.g., stopping at inter-frame pixel differences). In these cases, the light compression algorithm may conform to the same video compression standard as that used to generate the original compressed video bitstream.

The present invention, however, is not so limited. In alternative implementations, the light compression processing will produce video data in the second video format that does not conform to the algorithm that was used to generate the original compressed video bitstream. For example, the light compression might involve re-encoding the fully decompressed MPEG video data in a JPEG format. In other possible implementations, the light compression algorithm might involve run-length and/or variable-length coding of inter-frame pixel differences without first applying a block-based transform or quantization.

Although not a limitation to the invention in general, in preferred implementations, the light compression involves only lossless compression steps, in order to avoid any further degradation to quality of the ultimate video playback beyond that already suffered during the video compression processing involved in generating the original compressed video bitstream. Light compression algorithms might take advantage of correlations in components of the image.

One possible light compression algorithm involves a combination of differential pulse code modulation (DPCM) followed by variable-length coding (VLC). For DPCM, the differences are taken between (spatially) successive samples from the same color component (e.g., R, G, or B). Since such successive samples are typically highly correlated, the corresponding differences will typically be small. These differences are then encoded with a variable-length code similar to a Huffman code. On decoding, a difference is first decoded from the VLC, and then added to the preceding reconstructed sample to reconstruct the current sample. This process continues as all the samples are reconstructed.

Additional Processing

In addition to the processing involved in decompressing the original video bitstream and the optional light compression/decompression, pre-processor 102 and/or display processor 106 may also perform additional video processing steps. These may include one or more of the following: changing the aspect ratio, changing the color space, noise reduction, frame-rate enhancement, and watermarking.

This additional processing may be performed for various ends. For example, resizing and color-space mapping allow a movie to be adapted to a particular projector with a particular set of primaries and a particular number of pixels. This allows a movie to be digitized and compressed only once, but nonetheless played back on any projector. For example, this enables a studio to make only one master of a movie, which can then be adapted at each different theatre to the particular equipment available there.

Processing such as frame-rate enhancement helps give the viewers a better experience at the theatre by reducing the apparent flicker. Watermarking can be added as additional security for forensic purposes.

Since all of this processing can be performed off-line by pre-processor 102, this additional processing can be implemented independent of the real-time playback processing of display processor 106. Moreover, different appropriate processing can be performed for each movie without worrying about the processor capability in the server.

Alternatives

In a preferred implementation, server 100 supports multiple different modes of operation such that the processing applied to each different video stream is independent of the processing applied to other video streams, and the processing applied to a particular video stream at one time is independent of the processing applied to that same video stream at other times. The mode of operation for each different application of processing by server 100 may depend independently on particular requirements for that application, such as the available processing power or business considerations. Depending on the particular application, pre-processor 102 might operate faster than real-time, at real-time, or slower than real-time.

Unlike real-time decompression of the prior art, the computing power needed for a server, such as server 100 of FIG. 1, can be independent of the compression algorithm used to generate the original compressed bitstream and might be dependent only on factors associated with the imagery, e.g., resolution and bit-depth. This means that any compression/decompression algorithm can be readily adapted to work in such a server, including algorithms not yet invented that may be highly compute intensive.

The present invention can guarantee the interoperability of various equipment and algorithms, e.g., compression standards. When new standards become available, a simple software adaptation becomes possible. Because the display step is decoupled from all of the other steps, the system can accommodate any and all interoperability concerns. The present invention can allow ready extensibility of the system to new and better encoding and decoding algorithms.

The server might be able to accommodate multiple bitstreams, which may be downloaded as part of a transfer of a bitstream. Thus, each bitstream file may carry with it the necessary code to decompress it, and the hardware itself can be completely decoupled from the compression codec technology. Alternatively, the content file could point to a remote site from which an appropriate codec could be downloaded if that particular code was not currently residing on the unit. Different codecs may be used for different material, as appropriate. For instance, each content provider could have a private compression scheme that it might feel was appropriate to its particular content, or even vary the compression algorithm from video stream to video stream.

Post-processing (e.g., by display processor 106) for image enhancement might be readily done without regard to any constraints imposed by the hardware. For example, noise reduction may be applied to the decompressed imagery before display. Images can be sized to the particular projector on which they are to be displayed, without concern that the projector or server will become obsolete. Post-processing to increase the frame rate can be applied if the particular server is connected to an appropriate projector.

Any file may be independent of the server and display. Thus, for example, a single file, sent to a particular theatre with a particular projector, can be resized and its color space can be adjusted to the projector available in that theatre, even if the file itself was created before the projector was available.

The server might never become obsolete as long as the projector doesn't change. The server might be able to drive whatever projector interface is available, regardless of the nature of the original file. For example, a server can adjust the output to drive a DVI (8-bit, RGB) interface or an SMPTE 292M (10-bit, YCbCr). The approach is completely scalable to higher resolution projectors as they become available in the future.

In typical applications, the processing of pre-processor 102 will complete for a given video bitstream before the processing of display processor 106 begins. The invention is not necessarily so limited. For example, the present invention can be implemented in a context in which the processing of pre-processor 102 and the processing of display processor 106 overlap in time for a single compressed video bitstream. This would apply, for example, to situations in which a relatively long or even continuous video bitstream begins to be received by server 100 at some time relatively near the scheduled time of display of the video content. In that case, the receipt and/or processing of the original compressed video bitstream by pre-processor 102 begins but does not complete before the scheduled display time. As such, display processor 106 begins to retrieve and process the video data in the second video format stored in memory 104 for the beginning of the video stream, while pre-processor 102 continues to store other video data in the second video format to memory 104 for the rest of video stream. As long as pre-processor 102 is able to “stay ahead of” or at least “keep up with” display processor 106, the video stream will be able to be displayed in a continuous, real-time manner. For example, if pre-processing for a two-hour movie ran 1.5 times slower than real time, it would take three hours to process the movie. In this case, after pre-processing for one hour, it would be possible to start playing the movie. At the end of two hours, both the pre-processing and the display of the movie would be complete, assuming that there was sufficient processing power in the server to perform both types of processing simultaneously.

Although the present invention has been described in the context of MPEG-type encoding, those skilled in the art will understand that the present invention can be applied in the context of other video compression algorithms.

Similarly, although the present invention has been described in the context of a video frame as a single entity, those skilled in the art will understand that the invention can also be applied in the context of interlaced video streams and associated field processing. As such, unless clearly inappropriate for the particular implementation described, the term “frame,” especially as used in the claims, should be interpreted to cover applications for both video frames and video fields.

The present invention may be implemented as circuit-based processes, including possible implementation as a single integrated circuit, a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A method, comprising:
(a) receiving a compressed video bitstream conforming to a first video format;
(b) processing the compressed video bitstream to generate video data in a second video format different from the first video format;
(c) storing the video data in the second video format; and
(d) retrieving and processing the stored video data for display.

2. The invention of claim 1, wherein the stored video data is retrieved and processed for real-time display.

3. The invention of claim 1, wherein processing the compressed video bitstream comprises fully decompressing the compressed video bitstream to generate fully decompressed video data.

4. The invention of claim 3, wherein storing the video data comprises storing the fully decompressed video data such that the stored video data does not have to be further decompressed for display.

5. The invention of claim 3, wherein:
processing the compressed video bitstream further comprises lightly compressing the fully decompressed video data to generate the video data in the second video format; and
processing the stored video data comprises lightly decompressing the video data in the second video format for display.

6. The invention of claim 5, wherein lightly compressing the fully decompressed video data is composed of applying one or more lossless compression steps.

7. The invention of claim 5, wherein lightly compressing the fully decompressed video data comprises performing differential pulse code modulation followed by variable-length coding.

8. The invention of claim 1, wherein processing the compressed video bitstream comprises partially decompressing the compressed video bitstream to generate partially decompressed video data.

9. The invention of claim 8, wherein storing the video data comprises storing the partially decompressed video data such that the partially decompressed video data is fully decompressed in accordance with the first video format for display.

10. The invention of claim 8, wherein:
processing the compressed video bitstream further comprises lightly compressing the partially decompressed video data to generate the video data in the second video format; and
processing the stored video data comprises (1) lightly decompressing the video data in the second video format to recover the partially decompressed video data and (2) fully decompressing the partially decompressed video data in accordance with the first video format for display.

11. The invention of claim 10, wherein lightly compressing the partially decompressed video data is composed of applying one or more lossless compression steps.

12. The invention of claim 1, wherein processing the compressed video bitstream comprises partially or fully decompressing the compressed video bitstream and additionally adjusting one or more aspects of the video data, wherein additionally adjusting the one or more aspects comprises one or more of changing aspect ratio of the video data, changing color space of the video data, performing noise reduction, enhancing frame rate, and watermarking.

13. The invention of claim 1, wherein processing the stored video data comprises adjusting one or more aspects of the video data, wherein additionally adjusting the one or more aspects comprises one or more of changing aspect ratio of the video data, changing color space of the video data, performing noise reduction, enhancing frame rate, and watermarking.

14. A machine-readable medium, having encoded thereon program code, wherein, when the program code is executed by a machine, the machine implements a method comprising:
(a) receiving a compressed video bitstream conforming to a first video format;
(b) processing the compressed video bitstream to generate video data in a second video format different from the first video format;
(c) storing the video data in the second video format; and
(d) retrieving and processing the stored video data for display.

15. A video server, comprising:
(a) a memory;
(b) a pre-processor connected to the memory; and
(c) a display processor connected to the memory, wherein:
the pre-processor is adapted to (i) receive a compressed video bitstream conforming to a first video format, (ii) process the compressed video bitstream to generate video data in a second video format different from the first video format, and (iii) store the video data in the second video format into the memory; and
the display processor is adapted to retrieve and process the stored video data for display.

16. The invention of claim 15, wherein the display processor is adapted to retrieve and process the stored video data for real-time display.

17. The invention of claim 15, wherein the pre-processor is adapted to:
fully decompress the compressed video bitstream to generate fully decompressed video data; and
store the fully decompressed video data such that the stored video data does not have to be further decompressed for display.

18. The invention of claim 15, wherein:
the pre-processor is adapted to:
fully decompress the compressed video bitstream to generate fully decompressed video data; and
lightly compress the fully decompressed video data to generate the video data in the second video format; and
the display processor is adapted to lightly decompress the video data in the second video format for display.

19. The invention of claim 15, wherein:
the pre-processor is adapted to:
partially decompress the compressed video bitstream to generate partially decompressed video data; and
store the partially decompressed video data; and
the display processor is adapted to fully decompress the partially decompressed video data in accordance with the first video format for display.

20. The invention of claim 15, wherein:
the pre-processor is adapted to:
partially decompress the compressed video bitstream to generate partially decompressed video data; and
lightly compress the partially decompressed video data to generate the video data in the second video format; and
the display processor is adapted to:
lightly decompress the video data in the second video format to recover the partially decompressed video data; and
fully decompress the partially decompressed video data in accordance with the first video format for display.
